(19) United States
(12) Patent Application Publication
(10) Pub. No.: US 2026/0336325 A1
(43) Pub. Date: Oct. 29, 2026

(54) STACKABLE, TAMPER EVIDENT CLOSURE SYSTEM FOR METALLIC PAILS AND CONTAINERS

(71) Applicant: RIEKE LLC, Auburn, IN (US)

(72) Inventors: Anthony ANGELOZZI, Fort Wayne, IN (US); Jeff GREENFIELD, Auburn, IN (US); Ronald KIERAS, McHenry, IL (US)

(21) Appl. No.: 19/099,155

(22) PCT Filed: Jul. 31, 2023
(86) PCT No.: PCT/US2023/029062

§ 371 Date: Jan. 28, 2025

Related U.S. Application Data
(60) Provisional application No. 63/393,610, filed on Jul. 29, 2022.

(51) Int. Cl. B44D 3/12; B65D 21/02; B65D 25/42; B65D 51/20

(52) U.S. Cl. CPC B44D 3/127; B65D 21/022; B65D 25/42; B65D 51/20; B65D 2543/00972

(57) ABSTRACT

A closure system can be attached to existing paint pails, cans, and other, similar metallic containers. A ring, preferably metallic, is crimped to the terminal edge of the container, while a flange with an engagement extension protrudes radially inward at the container opening. A plastic closure insert couples to the extension, and that insert may include tamper evidence, a spout and/or other dispensing features, along with a cap. The cap includes radial lugs that allow for stacking a number of sealed containers on top of one another. The resulting system can be employed in existing closing and filling operations while maintaining a low profile (i.e., ≤0.75 inches and, more preferably, ≤0.50 inches of height above the crimped container edge).

### CROSS REFERENCE TO RELATED APPLICATIONS

This application claims priority to U.S. provisional patent application Ser. No. 63/393,610 filed on Jul. 29, 2022, which is incorporated by reference herein.

### TECHNICAL FIELD

The present invention relates to a closure system attachable to wide-mouthed containers and, more specifically, a system for use with paint containers having a crimped ring attached to a closure insert having various tamper evidence and storage features.

### BACKGROUND

Metallic cylindrical containers have been in use for decades. One conventional design for forming closures on such containers involves crimping or curling the metallic sidewalls around a top panel and/or a around an annular ring or insert which itself connects to that top panel. Often times, these closures are necessarily formed from metal so as to accommodate the crimping process. Examples can be found in U.S. Pat. Nos. 7,780,979; 7,886,899; 8,708,188; and 11,485,570.

While possessing advantageous physical characteristics, metallic components may not always be preferred. For example, metals tend to be more expensive and more difficult to form and work than selected polymers. Further, depending upon the contents of the container itself, some metals may require specialized coatings, which can be even more difficult in the event the metal is subsequently worked (e.g., via crimping).

Paint containers present peculiar challenges, given the variable compositions in paints and the need to provide a comparatively hermetic seal and easily opened and resealable closures. Given these requirements, “rim seal” metallic containers and closures, similar to the one shown in U.S. Pat. No. 5,161,689 and more generally recognized by the interference fit established between a flat circular closure with a peripheral formation that cooperates with a corresponding formation on an annular flange at/near the container neck, have become ubiquitous. And, owing to decades of use and capital investments, manufacturers and consumers alike may be hesitant to move away from closures that are either rim-sealed or that.

Other iterations and proposals for closures pertinent to paint containers can be found in U.S. Pat. Nos. 6,843,898; 7,137,525; 7,607,551; and 9,718,301. Generally speaking, these disclosures are examples of plastic containers and/or lids. However, only U.S. Pat. No. 7,137,525 appears to be suitable for prospective use in a conventional rim seal configuration.

The ability to detect potential tampering is another concern, especially to the extent paint can be adversely affected by exposure to ambient air (e.g., humidity, oxygen, etc.). U.S. Pat. Nos. 4,815,618 and 7,607,551; 9,718,301 provide examples for this functionality in non-rim-seal and plastic paint containers, while U.S. Pat. Nos. 4,534,481; 5,996,833; 6,360,908; 7,080,749; 7,537,132; and 7,568,585 provide examples of tamper-evident (TE) tear strips provided to caps used on industrial drums. Generally speaking, many of these designs disclose tamper evident features that employ single-use, frangible elements fitted over the closure opening and/or as a detachable strip positioned along an edge of a screw top closure.

All of the aforementioned patent documents are incorporated by reference. Further, to the extent compatible with the description below, further aspects of the invention may incorporate one or combinations of the features found in these conventional designs.

In view of the foregoing, a rim-seal paint container and closure having tamper evidence and constructed from lower cost materials, such as plastics, would be welcomed.

### SUMMARY

A closure system capable of serving as a suitable replacement for conventional rim-sealed metallic containers is contemplated. The system includes an overcap made from a polymeric and/or easily formed (e.g., injection or other molding) material, with a frangible element or panel formed within a concentric portion of the closure panel on the cap in some aspects. When so disposed, the frangible panel may be deliberately removed by applying upward or rotational force to detach element as a single, disposable strip and/or the panel itself. In either case, the remaining periphery of the cap remains intact as an annular ring attached to the container neck with an opening to access the internal volume of the container and, separately, with a cylindrical extension protruding up from the ring to allow for attachment of a rotatable and removable cap having a diameter that is less than the outer diameter of the container but greater than the outer diameter of the cylindrical extension.

In another aspect and in lieu of tamper evidence, the annular ring may be formed as a pouring spout. Preferably, the spout has sufficient diameter to receive the elongated shape of a standard paint brush. As above, the annular ring is configured to detachably receive an overcap.

In any of these aspects, the annular ring is attached to the metal container by a metallic ring connector. This connector is crimped to the terminal open end of the container or pail by conventional means along the outer periphery of the connector. The inner periphery of the connector extends radially inward with a serpentine, S-shaped, or question mark-shaped flange on the inner most edge. In this manner, the inner most edge is snap-fittingly received in a C-shaped channel on the annular ring, with a retention flange extending radially outward to secure and retain the terminal inner most edge of the connector. In this manner, the closure system can be implemented relying on similar or identical processes and machinery as may already be employed by conventional metallic rim-sealing discs.

Advantageously, the annular ring easily accommodates a screw cap, thereby eliminating the cumbersome, lever-action required to remove many conventionally rim-sealed containers. Further, the closure allows for tamper evidence and lower manufacturing costs. Lastly, the periphery of the overcap can be formed with a plurality of stacking flanges to so as to allow containers employing the closure system to be stacked in secure manner.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is an exploded perspective view of the metallic connector, metallic paint container or pail, and the bottom closure, as may be appropriate for use with any aspect of the inventive system.

FIG. 2A is a perspective view of the pouring notch on the annular ring (with the frangible panel removed) according to certain aspects. FIG. 2B is a partial cross-sectional side view taken along a portion the interface of the container's open edge and the insert/closure at a diameter that bisects that pouring notch.

FIG. 3A is a diametrical cross-sectional side view of the inventive system with a frangible panel removable, tamper evident strip, and overcap, with FIG. 3B showing a perspective exploded view of these components and FIG. 3C showing a perspective view of this system, including the features present when the cap and frangible panel are removed (and an optional implement, such as a paint brush shown, received through the annular ring to access fluid in the container).

FIG. 4A is a diametrical cross-sectional side view of the inventive system with a frangible panel removable by a bail handle and overcap, with FIG. 4B showing a perspective exploded view of these components and FIG. 4C showing a perspective view of this system, including the features present when the cap and frangible panel are removed to reveal the teardrop-shaped opening (and an optional implement, such as the paint brush shown, received through the annular ring to access fluid in the container).

FIG. 5A is a diametrical cross-sectional side view of the inventive system with a partial spout formed within the ring in lieu of a frangible panel and a modified overcap, with FIG. 5B showing a perspective exploded view of these components and FIG. 5C showing a perspective view of this system, including the features present when the cap is removed to expose the extended pour spout (and an optional implement, such as the paint brush shown. received through the annular ring to access fluid in the container).

FIG. 6A is a diametrical cross-sectional side view taken along the inventive system having a frangible panel and an overcap having stack lugs, and with the lower portion of an identical container to illustrate stackability. FIG. 6B is a partially exploded, perspective view with one quarter section removed from the insert and cap as well as the identical container elevated to better illustrate, the size, shape, and positioning of the stackable lugs.

FIG. 7A is a perspective exploded view of a low profile closure system having an integrated cap retained by a living hinge, while FIG. 7B shows these components assembled and the integrated cap flipped to an open position, thereby revealing the living hinge. FIG. 7C is a partial cross-sectional side view taken along a portion the interface of the container's open edge and the insert/closure with the cap engaged in the closed position.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The descriptions and drawings in this disclosure, and any written matter within the drawings should be deemed to be reproduced as part of this specification.

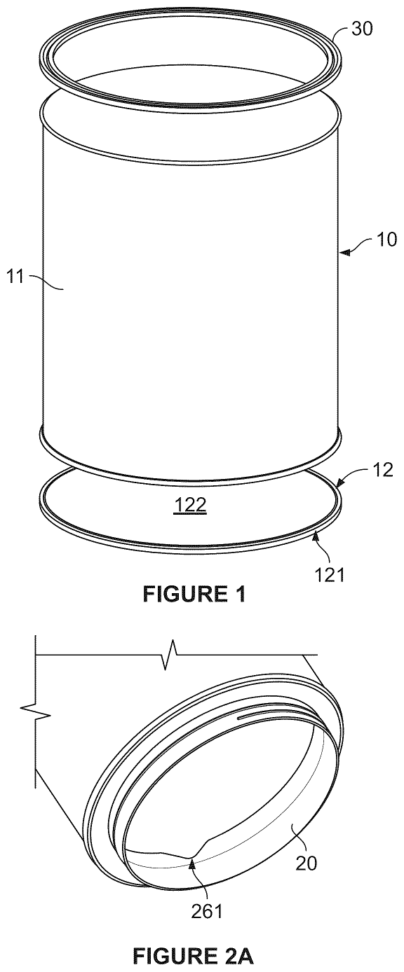

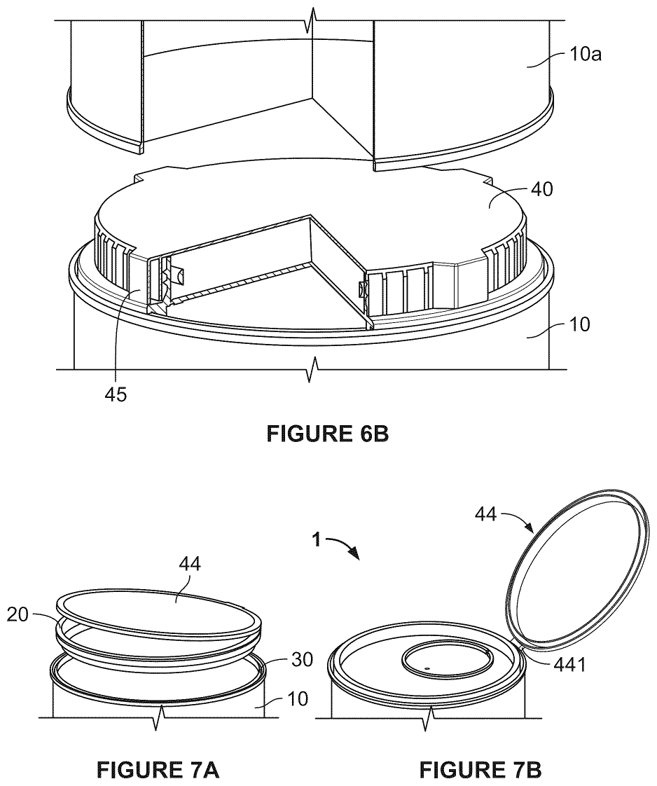

With reference to FIGS. 1 through 7C, various aspects and views of the closure system are provided (as described above). The various implementations of the closure system may be combined, and these separate views should not be considered as limiting.

Generally speaking, the system 1 comprises a container 10, an insert/annular ring 20, a connector ring 30, and an overcap 40. The insert/annular ring 20 is initially sealed by a frangible panel 27 and/or it may include an integrally formed spout 28, and it connects on its outer periphery to the connector ring 30 which is, itself, crimped to the top edge defining the opening of the container 10. The overcap 40 is detachably connected to the insert 20 so as to provide for a hermetic yet low profile seal if/when the frangible panel 34 is removed.

The container 10 includes metallic sidewalls 11, with a bottom panel 12 crimped at the lower edge of the sidewalls in a “beverage can” style connection similar to that described for crimping the outer section 31 to the sidewalls 11 (see below). In this manner, the bottom panel 121 includes a formable peripheral edge 121 and a flat central section 122 that conforms to the shape and/or contour of the top facing of the overcap 40 (and, more specifically, its top panel 41 and/or top panel extension 43). The sidewalls 11 and bottom panel 12 are made of metal, such as aluminum, various grades of steel, and other common alloys and materials, provided such materials are ductile and retain sufficient structural integrity so as to be amenable to the forming and crimping steps disclosed herein.

The annular ring and insert 20 includes an upright cylindrical extension 21 that may be threaded or provided with features 211 adapted to receive corresponding features on the skirt 42 of closure cap 40 (which is described in greater detail below). Unlike the container 10, ring/insert 20 is made from a low cost but durable plastic, such as an injection-molded polymer with sufficient strength and chemical compatibility to withstand the uses contemplated herein.

The insert 20 is also referred to as a ring because, in its final, operable position, it will attach to the opening at top of the container 10 via the connector 30. However, in some aspects, the annular ring 20 may initially include a frangible panel 27. This panel 27 is removable via a bail 273 and/or only after a tamper evident peripheral strip 274 (formed on an inner facing of the ring) is first removed. The panel serves as a form of tamper evidence, in addition to providing a additional hermetic seal beyond that provided by the cap 40. Back off lugs and/or retention projections (not shown) can be employed on the flange 21 or interfacing portions of the ring 20 and/or cap 40 to prevent unwanted twisting or removal of the insert 20 and/or cap 40 from the container 10/connector 30.

The panel 27 may have a circular shape that conforms to the shape of the opening on the container 10, or it may be an arcuate, tear-drop shape, or other curvilinear form that is selected to allow for insertion of a paint brush and/or facilitate pouring. In some aspects, a raised spout 28 may be provided (with or without the sealing panel 27 spanning the inner surface of the insert).

The panel 27 is connected to the main body of the ring 20 along thinned and/or perforated connector boundary 271 (the boundary conforming the aforementioned shapes). A thicker main panel 272 prevents leakage when the container is initially sealed, although use of the overcap 40 will provide redundant sealing protection.

In order to facilitate connection of the ring 20, an inner, downwardly directed skirt 26 may extend axially below the flange 21 and, in some aspects, axially below the radial retention flange 25. The inner diameter of skirt 26 will be the same as or smaller than the inner diameter at the top opening of the ring 20. One or more pouring notches 261, preferably having a V-shape, interrupt the skirt 26. Notches 261 may also permit the ring 20 to temporarily flex so as to facilitate attachment of the ring 20 to the other components of the system 1. Notches 261 also provide a pathway when the container is tilted in order to pour paint. When an integral spout 28 is provided, the notches 261 may aligned with the spout 28. Also, the notches may extend sufficiently upward toward the channel 23 so as to permit fluid to drain out that might otherwise be retained between the sidewall 11 and skirt 26 when the container 10 is tilted for pouring.

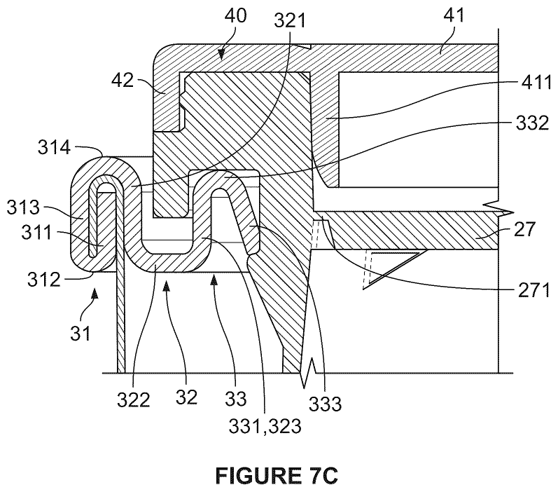

Skirt 26 may be vertically aligned or it may slope radially outward away from the central axis of the container 10 (as seen in FIG. 7C). In any instance, the skirt will taper inwardly as it extends downward away from the retention flange 25. Ribs or buttresses can be provided on the inner or outer facings to provide enhanced strength along the central opening defined by the skirt 25 and the cylindrical extension 21, with these formations being potentially significant to allow for tearing and removal of the frangible panel 27.

Spout 28 may be formed to match or remain below the axial height/extension of the flange 21. In this manner, a low profile flat cap 40 can be employed. The spout 28 may include a skirt connection 281 that partially or completely obstructs the opening otherwise defined by the inner facing of ring 20 (after the frangible panel 27 is removed, if one is present). A pour cylinder 282 extends upward from skirt connection 281. Connection 281 and cylinder 282 can be formed integrally (i.e., molded as a single piece) along with the other components comprising the ring/insert 20.

In the event an extended spout 28 is needed so that the cylinder 282 extends above the top edge of the cylindrical extension 21, a modified cap 40a can be provided. Here, an additional top panel extension 43 provides the needed axial clearance. The extension 43 includes a skirt 431 that is enclosed by an extension panel 432. The outer diameter of the extension panel 432 is necessarily smaller than the inner diameter of the opening at the top of cylindrical extension 21. The extension 43 can also conform the diameter of the bottom portion 122 so as to provide an alternate means of positioning and stacking containers 10, 10a.

An annular connector or crimp ring 30 is attached to the paint container 10 by curling the edge in “beverage can” style or similar fashion. The ring 30 is preferably metal, but couples to a plastic closure insert or annular ring 20. After the ring 30 is formed and attached to the container 10, an inner coupling section 33 protrudes radially inward and is received within an annular groove or retention channel 23 formed in the interfacing surface of the plastic insert/annular ring 20. This channel 23 creates C-shaped gap defined by an axial retention skirt 24 extending downward from a radial flange 22 on the main body, with a separate, lower retention bead or flange 25. This radial retention flange 25 prevents the connector 30 from being inadvertently dislodged. The lowermost edge of the retention skirt 24 terminates axially above the top facing of the retention flange 25, so as to create a pocket to receive the sealing interfaces of the connector 30 (as described below).

The inner coupling section 33 is configured to allow flexibility while being captured by the insert, with the crimped connection on its outer crimping section 31 keeps it secured to the container 10. A middle section 32 provides a guide channel bounded by an outer vertical wall 321, a radial groove or flattened section 322, and an inner vertical wall 323. The guide channel cooperates with axial retention skirt 24 to align and position the insert 20 relative to the connector 30. In some aspects, the connector ring 30 is made from the same material as the container 10 and, more specifically, the sidewalls 11 to which it is attached. Also, the material selected for the connector 30 can be sufficiently resilient so as to allow the insert 20 to be snap-fitted into place after the connector 30 is crimped onto the container 10. In order to add versatility, it may be possible to configure the guide channel and the groove section 322 to conform to conventional rim seal metal lids, thereby providing additional sealing mechanisms for a manufacturer or end user in the event the ring 20 is not provided or deliberately or inadvertently removed.

In terms of crimping or attaching the ring 30 to the container 10, a disc (preferably metallic) having a sufficiently ductile and workable periphery and a diameter that is preferably larger than that of the opening in the container is provided. This disc is centered on the axis of the cylindrical sidewalls 11 and the outer edges are bent (via swaging or other appropriate machinery). This causes the outer-most edge of the disc to be folded simultaneously with the terminal edge of the container. Ultimately, the container edge is bent around to a U-shape (i.e., where the edge is essentially parallel to or forms an acute angle with the main sidewall section). In doing so, the outer-most edge of the container is folded completely in around itself, so as to form a terminal section 311 that is encased by the container sidewall, while bottom transition curl 312 and top transition curl 314 are positioned on axially opposing ends of outer crimped portion 313 on that disc.

Simultaneously or subsequently, the middle section 32 in the periphery of the disc is also worked to form the guide channel. Thus, the outer vertical wall 321 of this channel conforms to the main sidewall section of the container (i.e., the inner portion defining the U-shape). This arrangement secures and seals the connector ring 30 and the sidewall 11. As noted above, this approach is also effective for securing the bottom panel 12.

Another important aspect of the connector 30 resides along its inner periphery. Here, a V- or U-shaped terminal edge is defined by the inner vertical wall 323 of the guide channel. This wall simultaneously serves as a vertically oriented interference-fit interface 331 between the connector 30 and the insert 20 (and, more precisely, an inner facing of the axial retention skirt 24). Transition section 332 also conforms to the underside of the insert 20 within the retention channel 23. Finally, at the inner terminal edge of the original disc, an angled interference-fit interface 333 engages an outer axial facing on the main body of the insert 20 that defines the retention channel 23 itself. Interface 333 may also come into contact with the radial bead/retention flange 25, either temporarily as the components are coupled or permanently as an additional sealing face.

The angled portion of inner section 33 is key to coupling the insert 20. In particular, the angled section 333 will occupy an axial height that conforms to and/or is smaller than the axial height of the retention channel 23, while the radial width of the inner section 33 is also sized to conform to and/or be smaller than the corresponding radial dimension of the channel 23. The opening of the channel 23 (defined by the linear distance between the ends of the axial skirt 24 and the radial retention flange 25) is sufficiently large to receive and substantially encase sections 331, 332, and 333. Notably, the angled section 333 is resilient so as to create biasing force that facilitates coupling and also retains the interference-fit interfaces 331, 333.

The cap 40 may be detachable or it can be an integrally formed cover element 44 affixed to the insert 20 by way of living hinge 441. Structurally, the cap 40 has an axial skirt 42 with optional threads or coupling features 421 on one or both facings (inner and/or outer). A top panel 41 fully encloses and seals the skirt 42, and an additional plug seal/skirt 411 can be provided coaxially on the bottom facing of the panel adjacent to the skirt 42. On its outer periphery, the skirt 42 may include a plurality, preferably at least three or four and possibly as many as five, six, seven, or eight bump outs or lugs 45 extending radially outward from the periphery of skirt 42. These lugs 45 help improve grip when removing the cap (particularly if/when the cap is threadingly engaged to the insert), and they are configured with sufficient size and strength to bear stacking loads. Preferably, the lugs 45 are formed at diametrically opposed edges of the top panel 41 so at to define a diameter that cooperates (i.e., nests within) the inner diameter of the flat bottom portion 122 on a similarly constructed container 10a. In this manner, cans are partially seated and retained in stacks. The lugs 45 should not extend beyond the outer diameter of the insert 20.

The system, in all of its various forms, is suited for attachment to standard sized paint containers, including those having a nominal inner diameter of 3.150 inches. In some aspects, the system is designed to have an inner diameter of 3.472 inches, although the means for attaching the crimp ring and insert are fully compatible with existing/standard container closing methods. In fact, it is expected that the solid circular bottom of the container (see FIG. 1) will crimped to the sidewall portion using the same machinery and methods as employed to crimp the ring to its top. In this manner, the stacking/nesting functionality of the lugs with the container bottom can be easily executed and reproduced.

The shape of the crimp ring and the cooperating annular groove in the insert results in a closure system with an exceptionally low profile. Even in the aforementioned standard sizes, the system will add less than 0.75 inches (when an extended pouring spout is used), 0.50 inches, or even as little as 0.125 inches (when an integral cap is used) to the height above the crimp connection of the container and ring.

Notably, the positioning of the retention channel 23 on the insert 20, creates a C-shaped connection point for the extension arm of the ring (i.e., the inner section 33). The extension arm is inset coaxially from the crimped connection (i.e., the outer section 31) with the container so that a skirt-like projection of the insert is seated partially between the crimp and the extension arm. This produces an arc receiving section on the insert that extends over 180 degrees and possibly over 270 degrees and even up to 315 degrees around the extension arm.

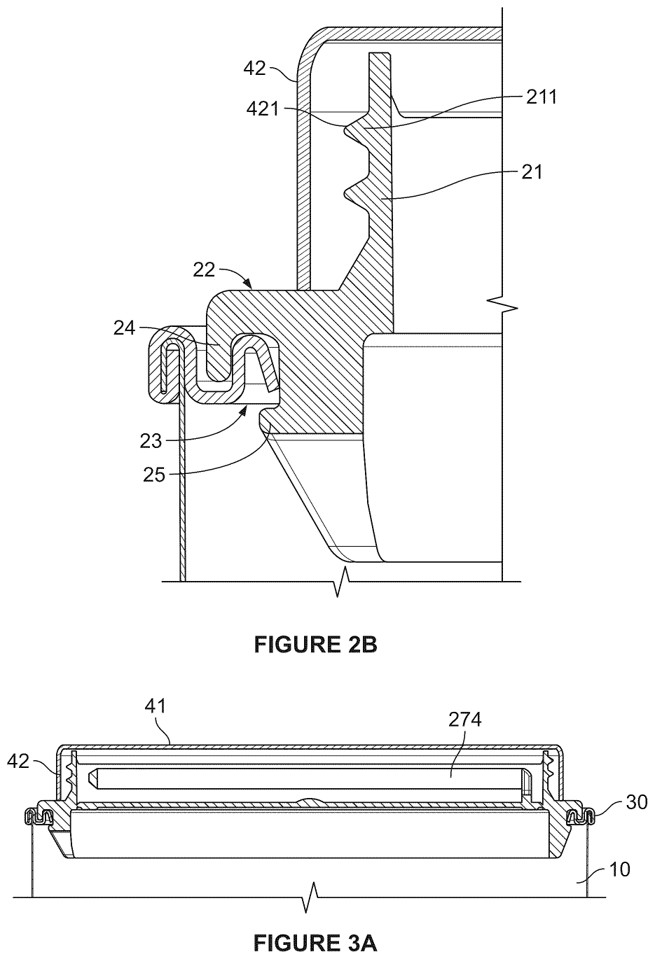

The extension arm will have a V-like shape. In some aspects one leg of the V will run vertically so as to be essentially parallel to the container side wall. The second leg of the V projects downward and forms an acute angle relative to the first leg. Preferably this angle is less than 60 degrees, less than 45 degrees, less than 30 degrees, and at least 10 degrees. Particularly when the ring and extension arm are formed from metal (such as steel, aluminum, or identical materials to that used in the container 10), the arm will impart spring-like qualities to accommodate coupling of the insert to the ring. The axial height of the extension arm is less than or equal to the height of the crimped connection (i.e., ring to container). The radial footprint (i.e., from the outer diameter of one edge of the crimp to the inner diameter of the extension arm, as depicted in FIG. 2A) is greater than or equal to its axial height.

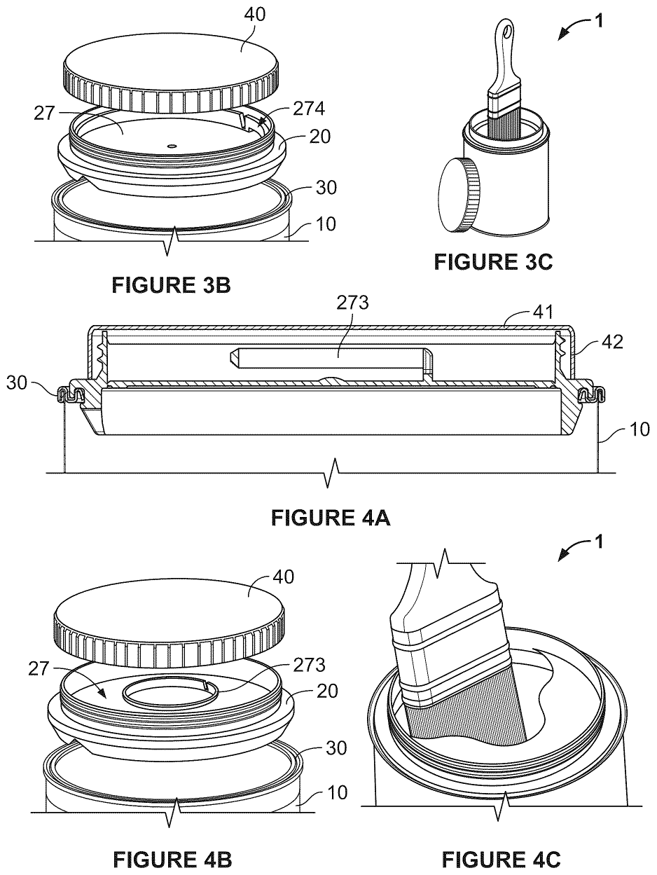

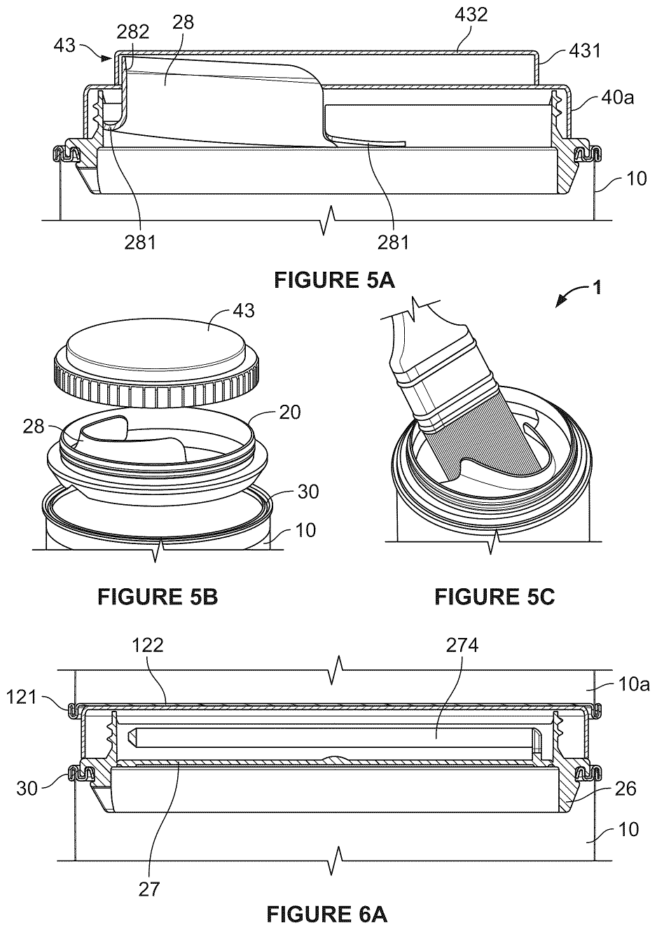

Notably, FIGS. 3A, 4A, and 5A are drawn to scale. Therefore, it will be appreciated that certain comparative distances in and among the components shown in these figures can be inferred. By way of example rather than limitation, the inner diameter of cylindrical extension 21 in FIG. 5A is smaller than the inner diameter at any point in the skirt 26 and with respect to the diameter between the outer (or, on the skirt 24, inner) facings of the retention channel 23. Similarly, in all of the aforementioned figures, the axial height of the cylindrical extension 21 is larger than the axial height of the portion of the insert 20 defining the retention channel 23, and the crimped outer section 31 has a larger axial height but smaller radial footprint in comparison to the of the interference-fit creating inner section 33. Any and all of these (and other) inferred relationships can and should be considered as part of this written disclosure. Similarly, except for aspects providing a pour spout, the central opening defined by the cylindrical extension 21 is and should be maximized to receive paint brushes and/or otherwise provide easy access to fluid (e.g., paint) carried within the internal volume of the container.

The foregoing configurations are specifically designed to provide for a comparatively low-profile closure system, both at the top and bottom of the container. This low profile will allow for easy stacking and storage of multiple containers, and the use of lugs and cooperating/nesting diameters (as described above) will enable manufacturers and retailers to more efficiently stack, store, and display a larger number of containers.

In one aspect, the invention contemplates closure system for paint containers. In its broadest form, this system has an annular connector element with an outer periphery configured to be coupled to a container in crimped arrangement, a middle section defining a guide channel, and an inner periphery having two angled wall sections collectively occupying a radial width and an axial height, with one of the angled wall sections configured to create biasing force; an insert element having a maximum outer diameter that is less than an outer diameter of the guide channel, wherein the insert element includes a central opening defined by an axially extending cylindrical section on a top facing of the insert element and a retention channel: i) positioned an outer periphery of the insert element, and ii) defined by an axial retention skirt and a radial retention bead; and an overcap configured to couple to a top facing of the insert element so as to selectively seal the central opening.

Additional aspects of the invention build off the foregoing by including a number of features that can be implemented in a variety of ways. These various aspects include any one or combination of at least portions of the following: (i) the insert element includes a frangible panel formed integrally with the insert element and configured so as to initially seal the central opening, with the frangible panel having a circular shape conforming to the inner diameter of the axially extending cylindrical section or a teardrop-shape and, optionally, with a frangible strip (possibly removed concurrently with the frangible panel) disposed around at least a portion of an inner facing of the central opening and/or a handle on a top facing concealed when the overcap is coupled to the insert element; (ii) the central opening includes a spout with a skirt connection attached to an inner facing of the axially extending cylindrical extension and a pouring cylinder extending coaxially within the axially extending cylindrical extension; (iii) the overcap includes a top panel extension to accommodate the spout; (iv) an axial height of the outer section of the connector element is larger than the axial height of each of the angled wall sections of the inner periphery; (v) the radial width and the axial height of the angled wall sections of the inner periphery conform to and create a plurality of sealing interfaces with inner surfaces of the retention channel; (vi) the overcap includes a plurality of radially extending, load-bearing lugs configured to allow stacking of a plurality of containers sealed by the closure system; (vii) the overcap is integrally formed with the insert element and connected thereto by way of a living hinge; and (viii) the overcap includes a plug sealing skirt extending from a lower facing of a top panel in the overcap, with the plug sealing skirt coaxially disposed within an axial, threaded skirt also extending from the lower facing.

Still other aspects of the invention can be discerned from this description and its accompanying drawings, as well the context of the invention in comparison to the background items noted above. Various methods and components contemplated herein should be considered part of these aspects.

All components should be made of materials having sufficient flexibility and structural integrity, as well as a chemically inert nature. The materials should also be selected for workability, cost, and weight. In addition to the materials specifically noted above, common polymers amenable to injection molding, extrusion, or other common forming processes should have particular utility, although metals, alloys, and other composites may be used in place of or in addition to more conventional materials. Various grades of low density polyethylene are expected to have particular utility in view of the design goals and requirements noted above.

References to coupling are to be understood as encompassing any of the conventional means used in this field. This may take the form of snap-or force fitting of components, although threaded connections, bead-and-groove, “beverage can” and other forms of crimping, and bayonet-style/slot-and-flange assemblies could be employed. Adhesive and fasteners could also be used, although such components must be judiciously selected so as to retain the functionality of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

References sealing or being in a sealed state means that interfacing components are in sufficient and intimate contact to prevent unwanted fluid flow across that interface. These fluids may be liquid (e.g., dispensed fluids) or gaseous (e.g., ambient air). These seals can be temporary, as may be the case with the removable caps, so that the interfacing surfaces are capable of sliding over/across one another. In other instances, the seal is intended to be permanent, so that the aforementioned coupling arrangements or force fittings created by a “plug seal” arrangement (in which an edge or flange is forced fitted into a gap on the other component) are effective and appropriate. In the drawings, it will be understood that sealing features are or may need to be employed, particularly in those areas where a non-linear interface appears.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A closure system for paint containers, the system comprising:
an annular connector element with an outer periphery configured to be coupled to a container in crimped arrangement, a middle section defining a guide channel, and an inner periphery having two angled wall sections collectively occupying a radial width and an axial height, with one of the angled wall sections configured to create biasing force;
an insert element having a maximum outer diameter that is less than an outer diameter of the guide channel, wherein the insert element includes a central opening defined by an axially extending cylindrical section on a top facing of the insert element and a retention channel: i) positioned an outer periphery of the insert element, and ii) defined by an axial retention skirt and a radial retention bead; and
an overcap configured to couple to a top facing of the insert element so as to selectively seal the central opening.

2. The closure system of claim 1 wherein the insert element includes a frangible panel formed integrally with the insert element and configured so as to initially seal the central opening.

3. The closure system of claim 2 wherein the frangible panel has a circular shape conforming to the inner diameter of the axially extending cylindrical section.

4. The closure system of claim 2 wherein the frangible panel has a teardrop-shape.

5. The closure system of claim I the central opening includes a spout with a skirt connection attached to an inner facing of the axially extending cylindrical extension and a pouring cylinder extending coaxially within the axially extending cylindrical extension.

6. The closure system of claim 5 wherein the overcap includes a top panel extension to accommodate the spout.

7. The closure system of claim 1 wherein an axial height of the outer section of the connector element is larger than the axial height of each of the angled wall sections of the inner periphery.

8. The closure system of claim 1 wherein the radial width and the axial height of the angled wall sections of the inner periphery conform to and create a plurality of sealing interfaces with inner surfaces of the retention channel.

9. The closure system of claim 1 wherein the overcap includes a plurality of radially extending, load-bearing lugs configured to allow stacking of a plurality of containers sealed by the closure system.

10. The closure system of claim 1 wherein the overcap is integrally formed with the insert element and connected thereto by way of a living hinge.

11. The closure system of claim 1 wherein the overcap includes a plug sealing skirt extending from a lower facing of a top panel in the overcap, with the plug sealing skirt coaxially disposed within an axial, threaded skirt also extending from the lower facing.

12. The closure system of claim 2 wherein a frangible strip is disposed around at least a portion of an inner facing of the central opening.

13. The closure system of claim 12 wherein the frangible strip is removed concurrently with the frangible panel.

14. The closure system of claim 2 wherein the frangible panel includes a handle on a top facing that is concealed when the overcap is coupled to the insert element.
